(19) United States
(12) Patent Application Publication
(10) Pub. No.: US 2007/0086608 A1
(43) Pub. Date: Apr. 19, 2007

(54) Bone-conduction microphone and method of manufacturing the same

(75) Inventors: Yoichi Hashimoto, Sendai-shi (JP); Hideyuki Kawase, Sendai-shi (JP); Masahiko Fujita, Sendai-shi (JP); Yuji Nitobe, Sendai-shi (JP)

Correspondence Address: OLIFF & BERRIDGE, PLC, P.O. BOX 19928, ALEXANDRIA, VA, 22320, US

(73) Assignee: NEC TOKIN CORPORATION, Sendai-shi (JP)

(21) Appl. No.: 11/543,839

(22) Filed: Oct. 6, 2006

(30) Foreign Application Priority Data
Oct. 18, 2005 (JP) 2005-302975
Mar. 23, 2006 (JP) 2006-080012

(51) Int. Cl. H04R 25/00

(52) U.S. Cl. 381/178; 381/151

(57) ABSTRACT

According to an embodiment of the present invention, a piezoelectric element composing a detecting part of a bone-conduction microphone is cantilevered by being mechanically pressed into an element mounting opening of a supporting member in a microphone case while temporarily bonded to a connecting member including a signal communication spacer, a copper-made spacer, a tapered ground spacer, and an insulating spacer, and optionally reinforced and fixed by use of an adhesive. Hence, it is possible to provide a cantilevered bone-conduction microphone having a vibration detecting part that can be assembled with a simple structure by use of an eco-friendly bonding material, not a solder.

### BACKGROUND OF THE INVENTION

1. Field of the Invention

The present invention relates to a bone-conduction microphone used in a cell phone or a mobile device, and a method of manufacturing the same. In particular, the invention relates to a bone-conduction microphone suitable as an in-ear sound information transmitter utilizing bone-conducted (voice) sound vibrations and used as accessories of the cell phone or mobile device, or suitable as a pick-up sensor for detecting a bone-conducted sound of the sound information transmitter, and to a method of manufacturing the same.

Further, the present invention relates to a bone-conduction microphone for detecting bone-conducted sound vibrations and converting the vibrations into electric signals by use of a piezoelectric element. In particular, the invention relates to a bone-conduction microphone suitable for detecting vibrations of a sound conducted through the head bone and converting the vibrations into electric signals for use in communications by means of a bimorph or unimorph cell (piezoelectric element).

2. Description of Related Art

Along with recent widespread use of cell phones or mobile devices, a wide variety of types have been significantly developed as the above device. To give an example thereof, a compact in-ear sound information transmitter that enables hand-free conversations in the cell phones or mobile devices has been put to use. In the case of using this transmitter, a user puts a microphone and earphone portions of the sound information transmitter in the cavity of the concha. The transmitter thus has an advantage in that the user can make a conversation only by putting the microphone and earphone portions in the cavity of the concha. Further, since cell phones are used in noisy surroundings in many cases, an in-ear sound information transmitter for the cell phones adopts a bone-conduction microphone that is less influenced by ambient noises.

The aforementioned sound information transmitter includes a bone-conduction microphone and an earphone portion which are put in the cavity of the concha when in use. First, the bone-conduction microphone is put in the cavity of the concha to detect a bone-conducted sound in the cavity of the concha to transmit the sound in the form of voice output from a connected cell phone or mobile device. In addition, the earphone portion is put in the cavity of the concha together with the bone-conduction microphone to convert a received signal into a voice to output the voice to the user's external auditory canal as a received voice. Through the two processes, this sound information transmitter attains a hand-free function of a cell phone or the like.

In general, the bone-conduction microphone in put in the user's own cavity of the concha to detect a (voice) sound generated in the vocal band and conducted through the head to reach the cavity of the concha (bone-conducted sound=vibration) as vibrations of the cavity of the concha. That is, this bone-conduction microphone is composed of a vibration sensor to precisely detect vibrations at contact surfaces in the cavity of the concha. Thus, this microphone needs to be compact and lightweight for improving a detection performance.

There have been reported many sound information transmitters including the bone-conduction microphone and the earphone portion, for example, a transmitter disclosed in Japanese Unexamined Patent Publication No. 9-331591.

Further, in a electronic equipment as disclosed in Japanese Unexamined Patent Publication No. 8-330887 or No. 2005-55305, the piezoelectric element is cantilevered on a substrate through a metal spacer by use of a conductive adhesive, or a conductive adhesive replaces a solder. In this case, the conductive adhesive serves as a conducting member of an electrode on one side, thereby simplifying the wiring configuration.

A holding method using the conductive adhesive needs to connect and hold components with high rigidity in order to ensure a high sensitivity and avoid a resonance point at a voice frequency band. In this regard, it is indispensable to use a conductive adhesive curable at around 150° C. under present circumstances.

The above method of fixing components based on soldering causes a damage of the components due to heating for soldering and a deterioration in characteristics, and thus has a problem in terms of performance stability and quality assurance.

### SUMMARY OF THE INVENTION

In view of the above circumstances, an object of the present invention is to provide a bone-conduction microphone having a vibration detecting portion that can be assembled without the use of a solder, and a method of manufacturing the same.

The above adhesive-based assembly needs to secure a piezoelectric element in a predetermined position, and fix the element by means of a jig in each of plural divided bonding and assembling steps to place the element in a high-temperature furnace for a predetermined period. This assembly is therefore disadvantageous in that many jigs are necessary for mass-production, and the steps cannot be executed in parallel, resulting in an increase in the total processing period. Further, a supporting rigidity depends on the conductive adhesive alone, so the rigidity and strength are insufficient in many cases, and a resonant frequency tends to be lowered. Further, since a liquid with a high degree of freedom in shape is used, a finished quality varies in the bonding and supporting area, and a sensitivity and characteristic tend to vary.

With a view to solving the above problems, it is another object of the present invention to provide a bone-conduction microphone structure in which a unimorph or bimorph piezoelectric element can be cantilevered and an electrode can be connected, and which uses a conductive adhesive but does not utilize the conductive adhesive as a main measure of holding the element nor a main measure of connecting the electrode, and which need not to be put in a high-temperature tank while being secured to a jig, and thus ensures a high processing efficiency, a requisite holding rigidity, and a high reliability of electric connection. In brief, the present invention aims at providing a bone-conduction microphone that is manufactured using an eco-friendly bonding material through a simplified step of holding and bonding a piezoelectric element to be cantilevered.

In order to attain the above object, according to an aspect of the present invention, a bone-conduction microphone includes: one or more piezoelectric elements forming an electrode, and having one end unfixed as a free end and the other end fixed to a microphone case through a supporting member; a vibration detecting part detecting bone-conducted sound vibrations transmitted to the microphone case and composed of the one or more piezoelectric elements; a connecting member fixing the piezoelectric elements and transmitting an electric signal; and an element mounting opening formed in the supporting member, in which peripheral portions of end portions of the piezoelectric elements constituting the vibration detecting part and the connecting member are inserted.

Further, in the bone-conduction microphone, the peripheral portions of the end portions of the piezoelectric elements and the connecting member are mechanically pressed into the element mounting opening.

Further, in the bone-conduction microphone, a fixed portion that is fixedly fastened through the insertion is reinforced and fixed by use of an adhesive.

Further, in the bone-conduction microphone, the piezoelectric elements are made of piezoelectric ceramic materials of a square bar shape or square plate shape, and the element mounting opening has a rectangular shape.

Further, according to another aspect of the present invention, a bone-conduction microphone includes: one or more bimorph or unimorph piezoelectric elements of a rectangular plate shape where a first electrode surface and a second electrode surface are formed as an external electrode; and a vibration detecting unit where the piezoelectric elements are cantilevered to a supporting frame fitting having a square cylindrical portion with a rectangular hole, wherein a U-shaped insulating spacer made of an insulating material is inserted into the rectangular hole, one ends of the first electrode surface and a side surface of the piezoelectric elements are inserted into the rectangular hole while surrounded by an inner peripheral surface of the U-shaped insulating spacer, and the insertion spacer having a wedge portion is pressed in between the insulating spacer and one end of the first electrode surface of the piezoelectric element or between an outer surface of the insulating spacer and a surface of the rectangular hole such that one end of the second electrode surface of the piezoelectric element is brought into close contact with one surface of the rectangular hole.

Further, in the bone-conduction microphone, while the bimorph or unimorph piezoelectric elements are stacked and series-connected to form a piezoelectric element portion such that one ends of bimorph or unimorph piezoelectric elements sandwich a metal conducting spacer, one ends of the exposed first electrode surface and side surface of the piezoelectric element portion are inserted into the rectangular hole while surrounded by an inner surface of the U-shaped insulating spacer, and the insertion spacer having the wedge portion is pressed in between the insulating spacer and one end of the first electrode surface of the piezoelectric element portion or between an outer surface of the insulating spacer and a surface of the rectangular hole such that the second electrode surface as another exposed surface of the piezoelectric element portion is brought into close contact with one surface of the rectangular hole for attaining electric continuity.

Further, in the bone-conduction microphone, the bimorph or unimorph piezoelectric elements are arranged in juxtaposition inside the insulating spacer, one end of the first electrode surface of the piezoelectric element portion is inserted into the rectangular hole to contact an inner peripheral surface of the U-shaped insulating spacer, and the insertion spacer having the wedge portion is pressed in between the insulating spacer and the first electrode surface of the piezoelectric element portion or between an outer surface of the insulating spacer and a surface of the rectangular hole such that one end of the second electrode surface of the piezoelectric element portion is brought into close contact with one surface of the rectangular hole for attaining electric continuity.

Further, in the bone-conduction microphone, the insertion spacer is made of metal, and pressed into between the first electrode surface of the piezoelectric element portion and the insulating spacer to serve as an electrode electrically continuous to the first electrode surface of the piezoelectric element portion.

Further, in the bone-conduction microphone, the supporting frame fitting electrically continuous to the second electrode surface of the piezoelectric element portion is used as a ground-side electrode, and connected with a ground pattern of a circuit substrate that composes an amplifying circuit and fixed and held to cantilever the piezoelectric element portion on the circuit substrate.

Further, in the bone-conduction microphone, the supporting frame fitting electrically continuous to the second electrode surface of the piezoelectric element portion is used as a ground-side electrode, and connected with a ground pattern of a circuit substrate that composes an amplifying circuit and fixed and held to cantilever the piezoelectric element portion on the circuit substrate, and an electrode electrically continuous to the first electrode surface of the piezoelectric element portion is directly connected with a signal-side pattern of the circuit substrate.

Further, in the bone-conduction microphone, a ground pattern is formed on a large area of a rear surface opposite to a piezoelectric-element-bearing surface of the circuit substrate on which the piezoelectric element portion is mounted, a case covering an impedance converting part and the piezoelectric element portion mounted to the circuit substrate is made of a conductor or a case inner surface is covered with a conductive coating film, and the case is electrically continuous to the ground pattern on the circuit substrate to attain an electrical shielding effect.

Further, in the bone-conduction microphone, the case is a body contact portion for picking up bone-conducted sound vibrations.

Further, according to still another aspect of the present invention, a method of manufacturing a bone-conduction microphone including one or more piezoelectric elements forming an electrode, and having one end unfixed as a free end and the other end fixed to a microphone case through a supporting member, and a vibration detecting part composed of the one or more piezoelectric elements, includes: semi-fixing peripheral portions of end portions of the piezoelectric elements constituting the vibration detecting part and a connecting member fixing the piezoelectric elements and transmitting an electric signal in a temporarily bonded state by use of a conductive adhesive; pressing the peripheral portions of the end portions of the piezoelectric elements temporarily bonded through the semi-fixing, into an element mounting opening formed in the supporting member; and completely curing the conductive adhesive.

Further, according to still another aspect of the present invention, a method of manufacturing a bone-conduction microphone including one or more piezoelectric elements forming an electrode, and having one end unfixed as a free end and the other end fixed to a microphone case through a supporting member, and a vibration detecting part composed of the one or more piezoelectric elements, includes: inserting peripheral portions of end portions of the piezoelectric elements constituting the vibration detecting part and a connecting member fixing the piezoelectric elements and transmitting an electric signal into an element mounting opening formed in the supporting member; and pressing a ground spacer grounding one electrode of the piezoelectric elements and having a tapered insertion portion into the element mounting opening to fix the peripheral portions of the end portions of the piezoelectric elements to the supporting member.

Further, the method of manufacturing a bone-conduction microphone further includes: pressing the ground spacer into the element mounting opening of the supporting member to fix the peripheral portions of the end portions of the piezoelectric elements, and reinforcing the fixed portions by use of an adhesive.

As mentioned above, according to the present invention, it is possible to fix a supporting portion of piezoelectric elements with a simple structure without soldering and improve a yield. Hence, an inexpensive bone-conduction microphone can be manufactured and provided with high performance and quality stabilities. That is, it is possible to provide a bone-conduction microphone including a vibration detecting part that can be assembled with a simple structure without soldering, and a method of manufacturing the same.

Further, according to the present invention, as described above, it is possible to a bone-conduction microphone that can cantilever a bimorph piezoelectric element as in the related art, can be assembled without connecting the electrode by use of a lead solder nor fixing the element to a jig and put in a high-temperature tank by use of a conductive adhesive, and can ensure a requisite holding strength and reliability in electrode connection. Accordingly, an eco-friendly material is used, and a production cost can be lowered.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a perspective view of a bone-conduction microphone according to an embodiment of the present invention;

FIG. 2 is a right-handed side view of the bone-conduction microphone according to the embodiment of the present invention;

FIG. 3 is an exploded perspective view of the bone-conduction microphone according to the embodiment of the present invention;

FIG. 4 is an exploded perspective view of a bone-conduction microphone according to another embodiment of the present invention;

FIG. 5 is a perspective view of an outer appearance of the bone-conduction microphone according to the embodiment of the present invention;

FIG. 6 is a side view of the bone-conduction microphone of FIG. 5;

FIG. 7 is a sectional view taken along the line G-G of FIG. 6;

FIG. 8 is an exploded perspective view of components of the bone-conduction microphone of FIG. 5;

FIG. 9 is a perspective view of each part in an assembly step;

FIG. 10 is a perspective view of main parts of the bone-conduction microphone according to the embodiment of the present invention; and

FIG. 11 is a perspective view of main parts of the bone-conduction microphone according to the embodiment of the present invention.

### DESCRIPTION OF THE PREFERRED EMBODIMENTS

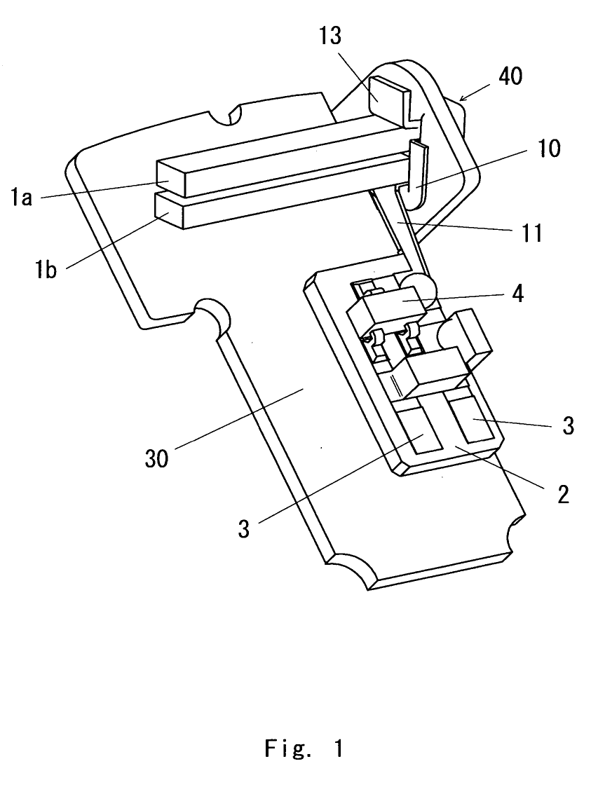

A bone-conduction microphone of an in-ear sound information transmitter according to an embodiment of the present invention has a pick-up sensor structure capable of detecting bone-conducted sounds of a low frequency to a high frequency. Thus, the most desirable structure and assembly method of a bone-conduction microphone are such structure and assembly method as do not apply extra stress or force to a piezoelectric element as an important part for detecting vibrations, and such structure and assembly method provide a stability in quality of a finished product. Hereinafter, embodiments of the present invention are described with reference to FIGS. 1 to 11.

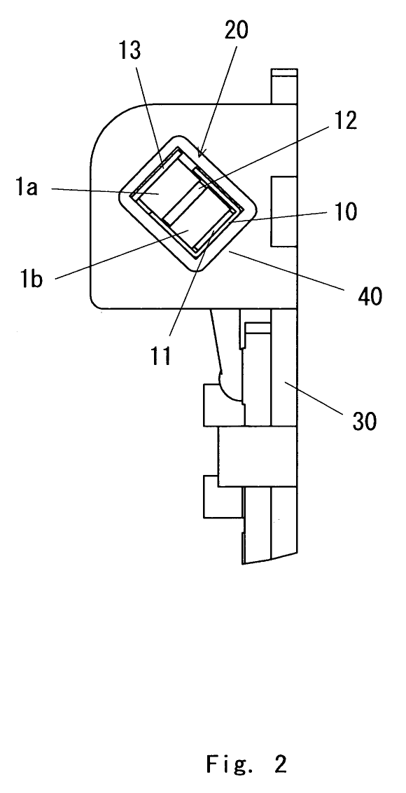

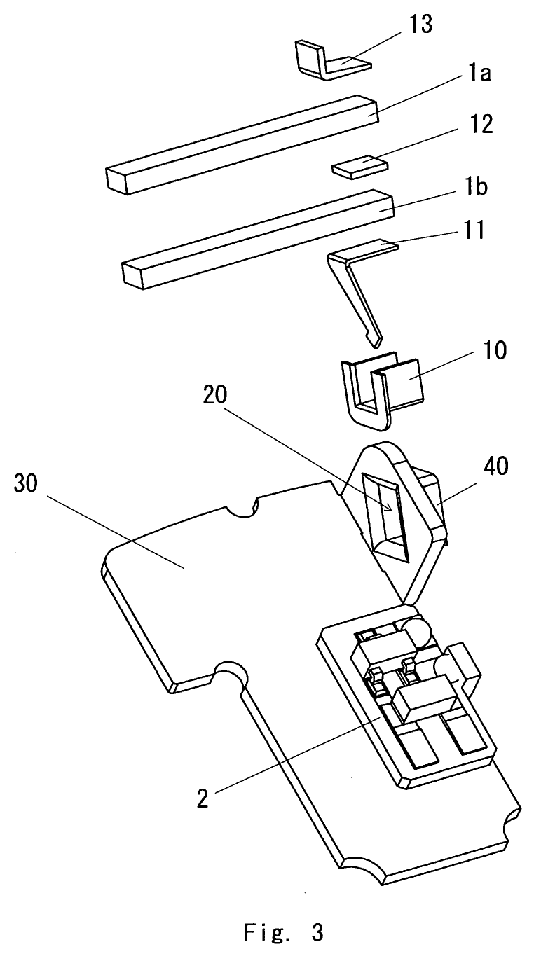

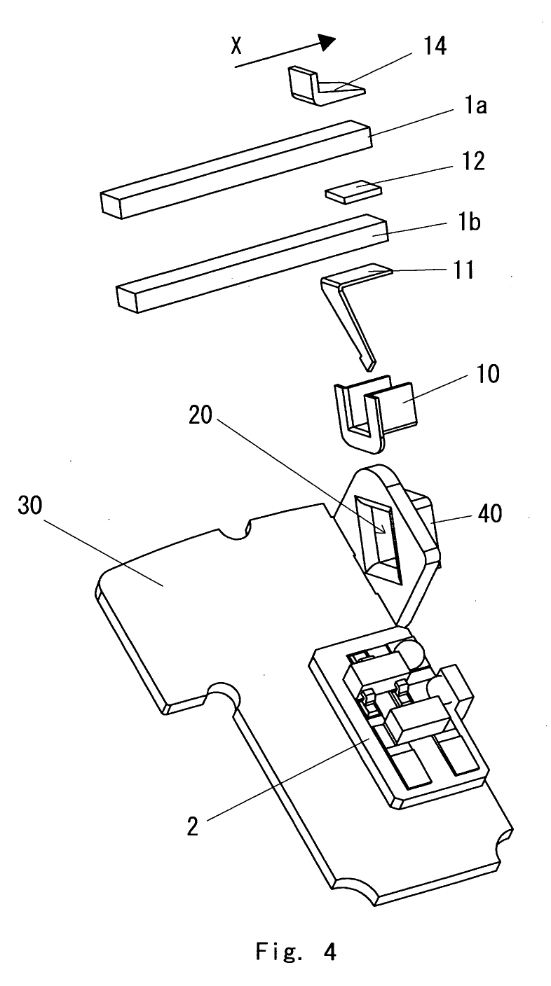

FIG. 1 is a perspective view of a bone-conduction microphone according to an embodiment of the present invention, and FIG. 2 is a right-handed side view of the bone-conduction microphone. FIG. 3 is an exploded perspective view of the bone-conduction microphone according to the embodiment of the present invention, and FIG. 4 is an exploded perspective view of a bone-conduction microphone according to another embodiment of the present invention.

To being with, the bone-conduction microphone according to the embodiment of the present invention is described. As shown in FIGS. 1 to 3, the bone-conduction microphone of this embodiment includes: a first piezoelectric element 1a and a second piezoelectric element 1b of a square bar shape or square plate shape, which have an electrode formed thereon and detect vibrations; an FET (field effect transistor) 4 having an impedance converting function and an amplifying function; a signal connection spacer 11, a copper-made spacer 12, and a ground spacer 13 for connecting these components; a microphone case 30 including a supporting member 40 having an element mounting opening 20; an insulating spacer 10 for ensuring an insulating property; and an element substrate 2 where the FET 4 or the like is secured in position.

If the bone-conduction microphone is applied with an external vibration force, the vibration force is transmitted through the microphone case 30 to the first piezoelectric element 1a and the second piezoelectric element 1b fixedly inserted into the element mounting opening 20 of the microphone case 30. As described above, one ends of the piezoelectric elements 1a and 1b are fixed, and the other ends thereof are free, so the elements can be freely moved. Hence, the elements freely oscillate on the fixed end within a range corresponding to the applied vibration force. In other words, the elements oscillate as an oscillator having a free end and a fixed end. At the same time, the piezoelectric element 1a and 1b generate electric signals corresponding to the applied vibrations at electrodes, and the generated signals are supplied to an input portion of an electric circuit on the element substrate 2 through the connected signal connection spacer 11 or transmitted to the ground side of the element substrate 2 from the electrode of the first piezoelectric element 1a through the ground spacer 13 to be transferred as an output of the bone-conduction microphone through the FET 4 of the element substrate 2 to a connected electric device such as a cell phone at an output terminal 3.

If the bone-conduction microphone is put in the cavity of the concha of a user the, bone-conduction microphone picks up sound vibrations (bone-conducted sounds) generated at the vocal band and modulated at the oropharynx or nasal cavity and then conducted through the mandibular or cranial bone or cartilage or living tissue to reach the cavity of the concha, converts the vibrations into electric signals, and transmits the signals to a connected device.

Next, the mechanically fixed structure and mechanically fixing structure of the piezoelectric elements of the bone-conduction microphone are described. As shown in FIG. 3, a detecting part of the bone-conduction microphone is completed by stacking the ground spacer 13, the first piezoelectric element 1a, the copper-made spacer 12, the second piezoelectric element 1b, the signal connection spacer 11, and the insulating spacer 10 in order, and temporarily bonding the above members by use of, for example, a conductive adhesive. The temporarily-bonded detecting part is pressed into the element mounting opening 20 of the supporting member 40 of the microphone case 30 as shown in FIG. 3, and the adhesive is cured through predetermined treatment and steps to compete the fixing of the bone-conduction microphone. The term “temporarily bonding” used herein means such a state that an adhesive holds members due to its viscosity and adhesion but the adhesive itself is uncured.

Subsequently, description is given of the piezoelectric elements of the bone-conduction microphone and of the way to electrically connect the piezoelectric elements. The aforementioned ground spacer 13, copper-made spacer 12, and signal connection spacer 11 are made of conductive materials, and the insulating spacer 10 is made of an insulating material. Therefore, one electrode of the first piezoelectric element 1a is connected with the ground spacer 13, and the other electrode of the first piezoelectric element 1a is connected with one electrode of the second piezoelectric element 1b through the conductive copper-made spacer 12. The other electrode of the second piezoelectric element 1b is connected with an input portion of the FET 4 of the element substrate 2 through the conductive signal connection spacer 11. The input connection portion is securely connected through a conductive adhesive or solder, and the signals detected with the piezoelectric elements are transmitted to the element substrate 2.

In this case, if the insulating spacer 10 cannot successfully function, the piezoelectric element 1a and 1b are contact with a peripheral portion of the element mounting opening 20 of the microphone case 30, which is made of a conductor to short-circuit the piezoelectric element 1a and 1b and cause deteriorations in output detection signal.

Next, another embodiment of the present invention is described below. In this embodiment, a fixing method (second fixing method) different from the above fixing method of the piezoelectric elements of the bone-conduction microphone is used. To elaborate on the fixing method of the piezoelectric elements, this method applies a conductive adhesive to the ground spacer 13, the first piezoelectric element 1a, the copper-made spacer 12, the second piezoelectric element 1b, the signal connection spacer 11, and the insulating spacer 10 to each, which constitute a detecting part as shown in FIG. 3, stacks these members in order, and presses the detecting part into the element mounting opening 20 of the microphone case 30 with these members being temporarily bonded. This method is advantageous in that the temporarily bonded members of the detecting part are pressed into the element mounting opening 20, so the pressing operation can be smoothly carried out. However, this method is disadvantageous in that a liquid conductive adhesive (or a conductive adhesive paste) should be applied between the members.

To that end, the second fixing method that omits the process of applying the conductive adhesive between the members and reduces the number of assembly steps is described hereinafter. That is, according to the second fixing method, the insulating spacer 10, the signal connection spacer 11, the second piezoelectric element 1b, the copper-made spacer 12, the first piezoelectric element 1a are inserted to predetermined positions of the element mounting opening 20 of the microphone case 30 of FIG. 4 in order, in a dry state, and finally, an insertion part mechanically presses the tapered ground spacer 14 into the element mounting opening 20 in the direction of the arrow X to fix the members with high mechanical rigidity. Further, after the fixing, the fixed portion is reinforced by use of an adhesive or the like as needed. The above second fixing method has an advantage in that the members constituting the detecting part can be assembled in the dry state.

Incidentally, one side of the element mounting opening 20 of FIG. 2 is inclined to the microphone case 30 surface by 45 degrees. However, the fixing method of the bone-conduction microphone according to the present invention can be implemented regardless of the angle between one side of the element mounting opening 20 and the microphone case 30.

Further, a case protecting the vibration detecting part and the electric circuit from any damage may be put on the side opposite to the microphone case 30 and may receive bone-conducted sounds.

The above embodiments describe the example where the vibration detecting part is formed using the first piezoelectric element 1a and second piezoelectric elements 1b. However, as the number of piezoelectric elements increases, the vibration detecting sensitivity increases. In contrast, the vibration detecting part may be formed using one piezoelectric element.

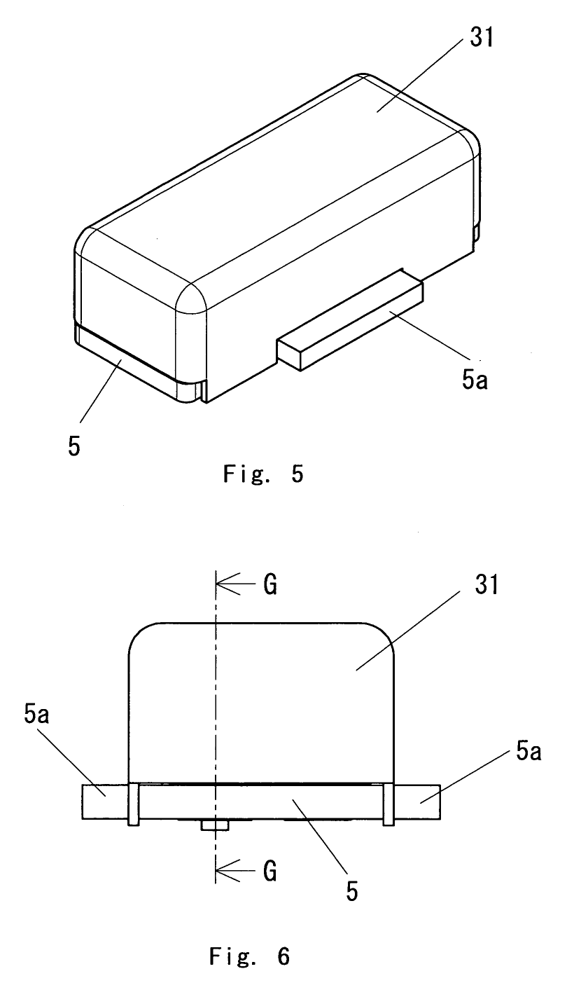

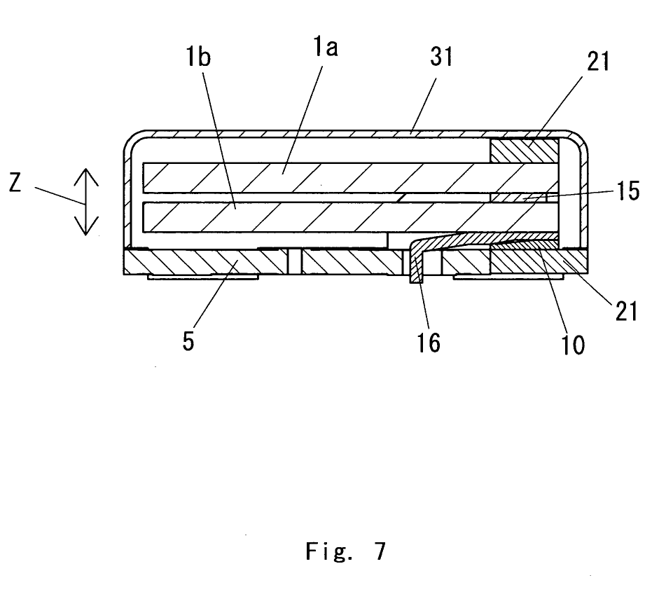

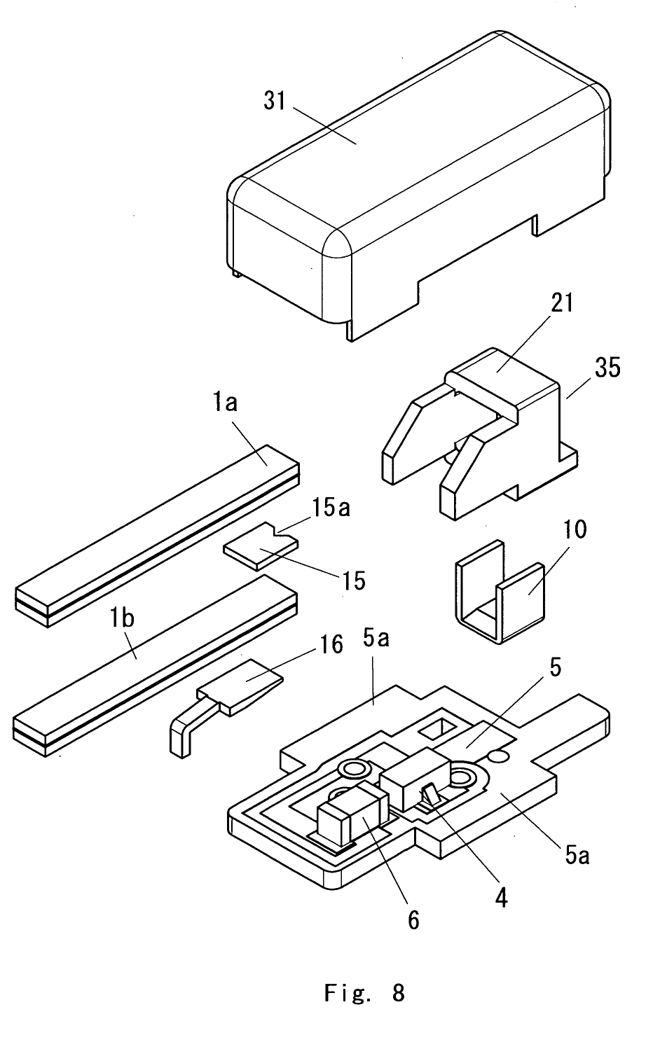

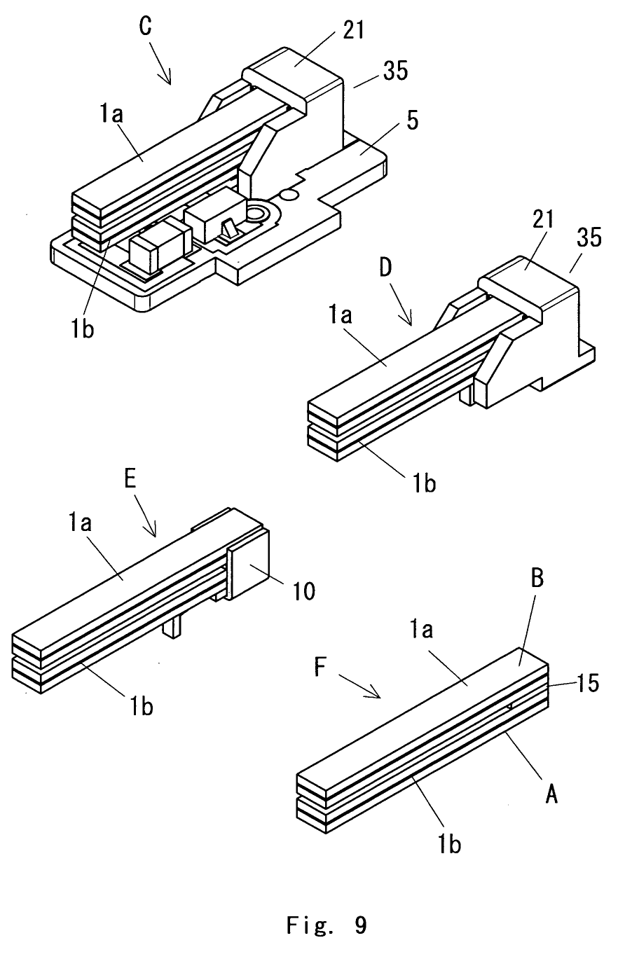

FIG. 5 is a perspective view of an outer appearance of the bone-conduction microphone, FIG. 6 is a side view thereof, and FIG. 7 is a sectional view taken along the line G-G of FIG. 6. FIG. 8 shows the bone-conduction microphone disassembled into components. FIG. 9 is a perspective view of the bone-conduction microphone in each assembly step; a portion C demonstrates the microphone with no case 31, a portion D demonstrates the microphone with no circuit substrate 5, a portion E demonstrates the microphone with no supporting frame fitting 21, and a portion F demonstrates the microphone with no insulating spacer 10.

Similar to the bimorph piezoelectric element 1a, upper and lower surfaces of the piezoelectric element 1b are covered with a silver coating film as an electrode. A copper-alloy conducting spacer 15 has a spacing function and a conducting function, and is provided between cantilevered end portions of the electrode surfaces of the piezoelectric element 1a and 1b. An electrode terminal 16 (insertion spacer with a wedge portion) of FIGS. 7 and 8 has a tapered shape that reduces its thickness toward the tip end, and contacts a first electrode surface A (FIG. 9) as a lower surface of the piezoelectric element 1b. The U-shaped insulating spacer 10 is arranged to surround the cantilevered end portions of the piezoelectric element 1a and 1b, the conducting spacer 15, and the electrode terminal 16, and a rectangular ring portion of a high-conductivity metal-made supporting frame fitting 21 in turn surrounds the insulating spacer 10.

The portion D of FIG. 9 illustrates an assembled state at the first stage. To describe the assembling order, the insulating spacer 10 is first inserted into a rectangular ring hole (rectangular hole 35 of a square cylindrical shape) of the supporting frame fitting 21, and the piezoelectric element 1b, the conducting spacer 15, and the piezoelectric element 1a are inserted into an inner space of the U-shaped insulating spacer 10 to stack one on top of the other. After that, the tapered portion of the electrode terminal 16 is pressed into a space between the inner surface of the insulating spacer 10 and the first electrode surface A as the lower surface of the piezoelectric element 1b.

The length of the rectangular hole 35 of the supporting frame fitting is set smaller than the total thickness of corresponding portions of the five members to be inserted (the piezoelectric element 1a and 1b, the conducting spacer 15, the insulating spacer 10, and the electrode terminal 16). When the electrode terminal 16 is pressed into the hole as a wedge, the members are brought into close contact with one another and also elastically deformed. As a result, the piezoelectric element 1a and 1b are cantilevered to the supporting frame fitting 21 in parallel with an interval corresponding to the thickness of the conducting spacer 15. Incidentally, the piezoelectric element 1a and 1b show the highest vibration detecting sensitivity in the direction of the arrow Z of FIG. 7.

The piezoelectric element 1a and 1b are cantilevered. In addition thereto, a second electrode surface B as the upper surface of the piezoelectric element 1a is brought into close contact with the inner surface of the rectangular hole of the supporting frame fitting 21, its lower electrode surface is brought into close contact with one surface of the conducting spacer 15, the upper electrode surface of the piezoelectric element 1b is brought into close contact with the other surface of the conducting spacer 15, and the first electrode surface A as the lower surface of the element 1b is brought into close contact with the electrode terminal 16 surface to attain an electrical continuity therebetween. Thus, the two piezoelectric elements 1a and 1b are series-connected on the electric circuit with the supporting frame fitting 21 and the electrode terminal 16 used as two electrode terminals.

A reliability in continuity therebetween is attained by securing clean contact surfaces, adopting an oxidation-resistant material, and keeping appropriate contact force in accordance with a reaction force of the elastic deformed members. In order to improve proof strength under various environmental conditions and ensure a holding stability, an insulating adhesive of high fluidity that can infiltrate into a gap as small as 10 μm may be applied to a gap between side surfaces of the piezoelectric element 1a and 1b and the insulating spacer 10 and between the insulating spacer 10 and the supporting frame fitting 21, and to the outer surface of a holding part.

Further, it is suitable for improving the reliability in electric continuity to supplementarily and partially apply a conductive adhesive that has low mechanical strength but high conductivity and is curable at ambient temperatures, to the outer peripheral portion of the contact surfaces of the connected electrodes after pressing the electrode terminal 16 into the opening. Here, a notch 15a is formed at the end of the conducting spacer 15. This is because a requisite surface area of the electrode to be connected is exposed for connection. That is, if a supplemental conductive adhesive for electrical continuity is applied to a V-shaped groove formed after the assembly, the electrical continuity can be more ensured. Regarding the other connecting part, some portions are exposed to facilitate the connection, so the part is not particularly cut out.

In any case, the above assembly steps do not require an operation of setting the elements in a positioning jig, putting the elements in a high-temperature tank, and curing a conductive adhesive. In addition, the piezoelectric elements can be held. without depending on an adhesive along, so its reliability is high, and high rigidity can be secured with ease.

The blocks assembled in the above assembly steps are stacked on the circuit substrate 5 on one side of which an impedance converting circuit is composed of the FET 4 and a capacitor 6, in such a manner that the supporting frame fitting 21 and the electrode terminal 16 as the two electrode terminals that series-connect the piezoelectric element 1a and 1b are connected in a predetermined pattern. Then, the blocks are fixed to one another. The rear surface opposite to the block-bearing surface of the circuit substrate 5 has ground patterns, solder lands, and signal-output solder lands (not shown) formed thereon. Incidentally, one or two amplifier parts may be provided on the downstream of the FET 4 to compose an amplifying circuit with the first amplifier used as an impedance converting part.

For fixing the circuit substrate 5 and the blocks of the piezoelectric elements to one another, connection portions of the supporting frame fitting 21 and the electrode terminal 16 may be soldered to patterns of the circuit substrate. In this case, even if a nonlead solder of a high melting point is used, heat treatment is speedily executed, so high temperature that would damage the piezoelectric elements is not applied.

Further, in such circumstances that soldering cannot be speedily executed, even if a conductive adhesive is used instead to conduct and fix the elements to the substrate, the elements have only to be arrayed before put into the high-temperature tank without the positioning jig. Further, a conductive adhesive curable at normal temperature may be used for connection, and another highly rigid adhesive curable at normal temperature may be used for holding the elements. In this case, a step of putting the elements into the high-temperature tank can be skipped.

After mounting the piezoelectric element blocks on the substrate, the case 31 having an electric shielding effect and made of a conductor or coated with a conductive coating film on the inner side is attached to cover a circuit portion. The case is connected with the ground-side pattern of the circuit substrate 5 to ensure an effect of shielding the high-impedance and noise-susceptible piezoelectric elements and impedance converting circuit from noise. Further, right and left supporting projections 5a (see FIG. 8, for instance) of the circuit substrate 5 support the bone-conduction microphone.

The upper and lower surfaces of the supporting frame fitting 21 are surrounded by the case 31 and the circuit substrate 5. Hence, the rigidity of the connected portion between the armor of the completely-assembled bone-conduction microphone and the supporting frame fitting 21 cantilevering the piezoelectric element 1a and 1b can be improved. When the armor is brought into close contact with the human body to pick up the sound vibrations, the vibrations can be transmitted to the piezoelectric elements without any loss.

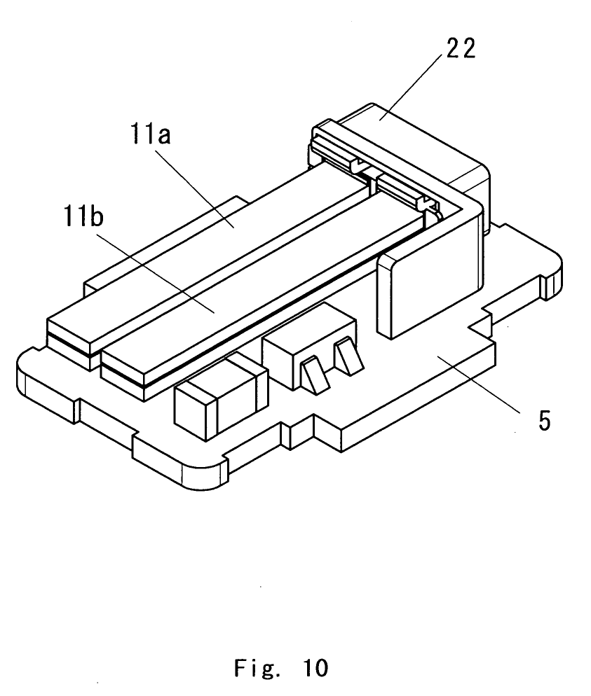

FIG. 10 is a perspective view of a main portion of the bone-conduction microphone where two piezoelectric elements are arranged in juxtaposition. That is, the second electrode surface B of the piezoelectric element 11a is parallel to that of the piezoelectric element 11b to form a piezoelectric element portion. Similar to the above example, the piezoelectric elements 11a and 11b are pressed into the rectangular hole of the ring portion 22 of the supporting frame fitting 21 together with the insulating spacer member, the conducting spacer member, the wedge member, and the electrode member. As in the above structure, this structure does not need to cure an adhesive in a high-temperature tank while the elements are put on the positioning jig. Further, the impedance converting circuit or amplifying circuit is formed on the circuit substrate 5 as in the above example.

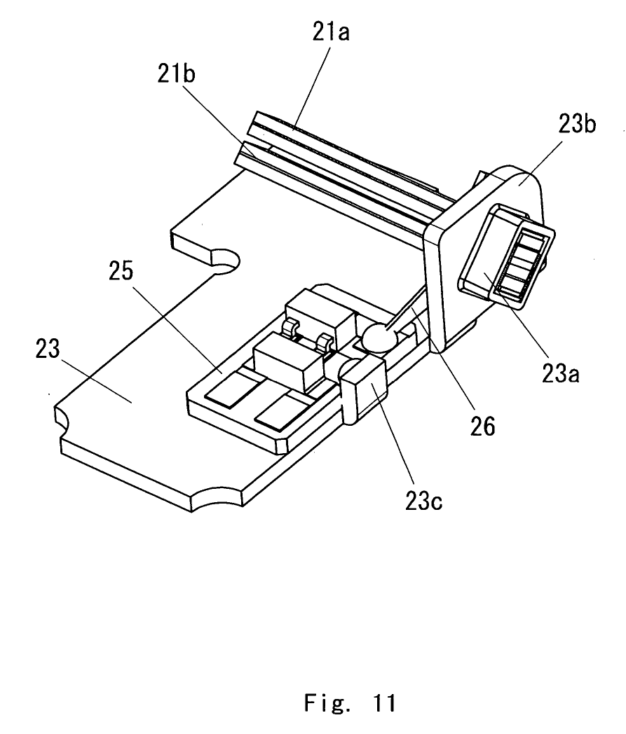

FIG. 11 is a perspective view of a main portion of the bone-conduction microphone. In the illustrated example, a substrate member 23 made up of a metal plate as the structure substrate of the entire product is press-bent to form a raised portion 23b. The ring portion 23a having a rectangular hole is formed in the raised portion 23b through drawing. The circuit substrate 25 is mounted on a main flat portion of the substrate member 23, and the ground pattern is connected with a projection 23c of the substrate member 23 as one electrode of the piezoelectric element. Further, the electrode member 26 as the other electrode of the piezoelectric element, which is pressed in between the piezoelectric element 21b and the insulating sheet member is connected with a signal pattern of the circuit substrate 25 (not shown). Similar to the above example, the structure of this embodiment does not need put the elements on a jig to cure an adhesive in the high-temperature tank.

The above embodiments describe the example where two bimorph piezoelectric elements are used. However, even in the case of using unimorph elements, the structure in which the first electrode surface and the second electrode surface are formed on both sides of a plate is the same as the bimorph element structure. Hence, the unimorph piezoelectric elements can be used in the present invention, and the number of piezoelectric elements may be one or three or more.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A bone-conduction microphone, comprising:
one or more piezoelectric elements forming an electrode, and having one end unfixed as a free end and the other end fixed to a microphone case through a supporting member;
a vibration detecting part detecting bone-conducted sound vibrations transmitted to the microphone case and composed of the one or more piezoelectric elements;
a connecting member fixing the piezoelectric elements and transmitting an electric signal; and
an element mounting opening formed in the supporting member, in which peripheral portions of end portions of the piezoelectric elements constituting the vibration detecting part and the connecting member are inserted.

2. The bone-conduction microphone according to claim 1, wherein the peripheral portions of the end portions of the piezoelectric elements and the connecting member are mechanically pressed into the element mounting opening.

3. The bone-conduction microphone according to claim 1, wherein a fixed portion that is fixedly fastened through the insertion is reinforced and fixed by use of an adhesive.

4. The bone-conduction microphone according to claim 3, wherein the piezoelectric elements are made of piezoelectric ceramic materials of a square bar shape or square plate shape, and the element mounting opening has a rectangular shape.

5. A bone-conduction microphone, comprising:
one or more bimorph or unimorph piezoelectric elements of a rectangular plate shape where a first electrode surface and a second electrode surface are formed as an external electrode; and
a vibration detecting unit where the piezoelectric elements are cantilevered to a supporting frame fitting having a square cylindrical portion with a rectangular hole,
wherein a U-shaped insulating spacer made of an insulating material is inserted into the rectangular hole,
one ends of the first electrode surface and a side surface of the piezoelectric elements are inserted into the rectangular hole while surrounded by an inner peripheral surface of the U-shaped insulating spacer, and
the insertion spacer having a wedge portion is pressed in between the insulating spacer and one end of the first electrode surface of the piezoelectric element or between an outer surface of the insulating spacer and a surface of the rectangular hole such that one end of the second electrode surface of the piezoelectric element is brought into close contact with one surface of the rectangular hole.

6. The bone-conduction microphone according to claim 5, wherein while the bimorph or unimorph piezoelectric elements are stacked and series-connected to form a piezoelectric element portion such that one ends of bimorph or unimorph piezoelectric elements sandwich a metal conducting spacer, one ends of the exposed first electrode surface and side surface of the piezoelectric element portion are inserted into the rectangular hole while surrounded by an inner surface of the U-shaped insulating spacer, and
the insertion spacer having the wedge portion is pressed in between the insulating spacer and one end of the first electrode surface of the piezoelectric element portion or between an outer surface of the insulating spacer and a surface of the rectangular hole such that the second electrode surface as another exposed surface of the piezoelectric element portion is brought into close contact with one surface of the rectangular hole for attaining electric continuity.

7. The bone-conduction microphone according to claim 5, wherein the bimorph or unimorph piezoelectric elements are arranged in juxtaposition inside the insulating spacer,
one end of the first electrode surface of the piezoelectric element portion is inserted into the rectangular hole to contact an inner peripheral surface of the U-shaped insulating spacer, and
the insertion spacer having the wedge portion is pressed in between the insulating spacer and the first electrode surface of the piezoelectric element portion or between an outer surface of the insulating spacer and a surface of the rectangular hole such that one end of the second electrode surface of the piezoelectric element portion is brought into close contact with one surface of the rectangular hole for attaining electric continuity.

8. The bone-conduction microphone according to claim 5, wherein the insertion spacer is made of metal, and pressed into between the first electrode surface of the piezoelectric element portion and the insulating spacer to serve as an electrode electrically continuous to the first electrode surface of the piezoelectric element portion.

9. The bone-conduction microphone according to claim 5, wherein the supporting frame fitting electrically continuous to the second electrode surface of the piezoelectric element portion is used as a ground-side electrode, and connected with a ground pattern of a circuit substrate that composes an amplifying circuit and fixed and held to cantilever the piezoelectric element portion on the circuit substrate.

10. The bone-conduction microphone according to claim 8, wherein the supporting frame fitting electrically continuous to the second electrode surface of the piezoelectric element portion is used as a ground-side electrode, and connected with a ground pattern of a circuit substrate that composes an amplifying circuit and fixed and held to cantilever the piezoelectric element portion on the circuit substrate.

11. The bone-conduction microphone according to claim 5, wherein the supporting frame fitting electrically continuous to the second electrode surface of the piezoelectric element portion is used as a ground-side electrode, and connected with a ground pattern of a circuit substrate that composes an amplifying circuit and fixed and held to cantilever the piezoelectric element portion on the circuit substrate, and an electrode electrically continuous to the first electrode surface of the piezoelectric element portion is directly connected with a signal-side pattern of the circuit substrate.

12. The bone-conduction microphone according to claim 10, wherein the supporting frame fitting electrically continuous to the second electrode surface of the piezoelectric element portion is used as a ground-side electrode, and connected with a ground pattern of a circuit substrate that composes an amplifying circuit and fixed and held to cantilever the piezoelectric element portion on the circuit substrate, and an electrode electrically continuous to the first electrode surface of the piezoelectric element portion is directly connected with a signal-side pattern of the circuit substrate.

13. The bone-conduction microphone according to claim 5, wherein a ground pattern is formed on a large area of a rear surface opposite to a piezoelectric-element-bearing surface of the circuit substrate on which the piezoelectric element portion is mounted, a case covering an impedance converting part and the piezoelectric element portion mounted to the circuit substrate is made of a conductor or a case inner surface is covered with a conductive coating film, and the case is electrically continuous to the ground pattern on the circuit substrate to attain an electrical shielding effect.

14. The bone-conduction microphone according to claim 8, wherein a ground pattern is formed on a large area of a rear surface opposite to a piezoelectric-element-bearing surface of the circuit substrate on which the piezoelectric element portion is mounted, a case covering an impedance converting part and the piezoelectric element portion mounted to the circuit substrate is made of a conductor or a case inner surface is covered with a conductive coating film, and the case is electrically continuous to the ground pattern on the circuit substrate to attain an electrical shielding effect.

15. The bone-conduction microphone according to claim 10, wherein a ground pattern is formed on a large area of a rear surface opposite to a piezoelectric-element-bearing surface of the circuit substrate on which the piezoelectric element portion is mounted, a case covering an impedance converting part and the piezoelectric element portion mounted to the circuit substrate is made of a conductor or a case inner surface is covered with a conductive coating film, and the case is electrically continuous to the ground pattern on the circuit substrate to attain an electrical shielding effect.

16. The bone-conduction microphone according to claim 12, wherein a ground pattern is formed on a large area of a rear surface opposite to a piezoelectric-element-bearing surface of the circuit substrate on which the piezoelectric element portion is mounted, a case covering an impedance converting part and the piezoelectric element portion mounted to the circuit substrate is made of a conductor or a case inner surface is covered with a conductive coating film, and the case is electrically continuous to the ground pattern on the circuit substrate to attain an electrical shielding effect.

17. The bone-conduction microphone according to claim 13, wherein the case is a body contact portion for picking up bone-conducted sound vibrations.

18. The bone-conduction microphone according to claim 16, wherein the case is a body contact portion for picking up bone-conducted sound vibrations.

19. A method of manufacturing a bone-conduction microphone including one or more piezoelectric elements forming an electrode, and having one end unfixed as a free end and the other end fixed to a microphone case through a supporting member, and a vibration detecting part composed of the one or more piezoelectric elements, comprising:
semi-fixing peripheral portions of end portions of the piezoelectric elements constituting the vibration detecting part and a connecting member fixing the piezoelectric elements and transmitting an electric signal in a temporarily bonded state by use of a conductive adhesive;
pressing the peripheral portions of the end portions of the piezoelectric elements temporarily bonded through the semi-fixing, into an element mounting opening formed in the supporting member; and
completely curing the conductive adhesive.

20. A method of manufacturing a bone-conduction microphone including one or more piezoelectric elements forming an electrode, and having one end unfixed as a free end and the other end fixed to a microphone case through a supporting member, and a vibration detecting part composed of the one or more piezoelectric elements, comprising:
inserting peripheral portions of end portions of the piezoelectric elements constituting the vibration detecting part and a connecting member fixing the piezoelectric elements and transmitting an electric signal into an element mounting opening formed in the supporting member; and
pressing a ground spacer grounding one electrode of the piezoelectric elements and having a tapered insertion portion into the element mounting opening to fix the peripheral portions of the end portions of the piezoelectric elements to the supporting member.

21. The method of manufacturing a bone-conduction microphone according to claim 20, further comprising:
pressing the ground spacer into the element mounting opening of the supporting member to fix the peripheral portions of the end portions of the piezoelectric elements, and reinforcing the fixed portions by use of an adhesive.
